(19) United States
(12) Patent Application Publication
(10) Pub. No.: US 2002/0033471 A1
(43) Pub. Date: Mar. 21, 2002

(54) Cesium formate containing coolant

(76) Inventors: Thomas H. Odle, Pottstown, PA (US); William J. Benton, Magnolia, TX (US)

Correspondence Address: Martha Ann Finnegan, Esq., Cabot Corporation, Billerica Technical Center, 157 Concord Road, Billerica, MA, 01821-7001, US

(21) Appl. No.: 09/873,125

(22) Filed: Jun. 1, 2001

Related U.S. Application Data
(60) Provisional application No. 60/209,077, filed on Jun. 2, 2000.

(51) Int. Cl. C09K 5/00

(52) U.S. Cl. 252/76

(57) ABSTRACT

A coolant composition containing at least cesium formate is described as well as the use of the coolant composition in radiators and other cooling devices. The coolant composition permits a variety of benefits to the engine performance and operation of the vehicle. Other uses for the cesium formate in cooling systems and other apparatuses are described.

This application claims the benefit under 35 U.S.C. § 119(e) of prior U.S. Provisional Patent Application No. 60/209,077 filed Jun. 2, 2000, which is incorporated in its entirety by reference herein.

### BACKGROUND OF THE INVENTION

The present invention relates to coolants, including engine coolants, and the benefits derived from the use of such engine coolants.

Coolant compositions are used in a variety of applications such as to cool engines like internal combustion engines. Water, aqueous solutions, and glycol containing solutions, especially ethylene glycol, are used as coolants or anti-freeze agents for these types of applications.

However, such compositions are limited by their ability to transfer heat away from the engine, and thus restrict the ability to run the engine at high output for long periods of time.

Accordingly, there is a need in the industry to provide improved coolant compositions which permit engines to run at higher output and/or for longer periods of time.

### SUMMARY OF THE INVENTION

A feature of the present invention is to provide a coolant composition which permits apparatuses such as engines to be run or operated at higher output and yet maintain acceptable engine operating temperatures.

Another feature of the present invention is to provide radiators or other heat distributing surfaces that use a lower or less grill surface area or a lower heat exchange surface area for the purposes of cooling the coolant composition.

Another feature of the present invention is to provide radiators and other cooling devices which require less coolant composition than conventional radiators and other cooling systems.

Another feature of the present invention is to provide engines and other apparatus which can be run at higher engine outputs without any negative effects on the operating parts.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

To achieve these and other advantages, and in accordance with the purpose of the present invention, as embodied and broadly described herein, the present invention relates to a coolant composition containing at least cesium formate.

The present invention further relates to a radiator containing a coolant composition which contains at least cesium formate.

The present invention further relates to a method to improve or promote corrosion resistance on surfaces of apparatuses, such as radiators and other cooling surfaces by using a coolant composition which contains at least cesium formate.

The present invention also relates to a method to clean surfaces of a radiator and other cooling devices and other surfaces using cesium formate. Thus, the present invention includes a method to clean corrosion on surfaces such as radiator surfaces using cesium formate.

Accordingly, the present invention also is a corrosion cleaner containing at least cesium formate.

The present invention further relates to a method to reduce the size of a radiator or other cooling device by using a cooling composition containing at least cesium formate.

The present invention further relates to a method to reduce the amount of coolant composition needed in a radiator or other cooling device and involves using a coolant composition containing at least cesium formate.

The present invention also relates to a method to reduce the surface area of the grill or heat exchange surface on a radiator or other cooling surface for purposes of cooling or reducing the temperature of the coolant composition by using a coolant composition containing at least cesium formate.

The present invention also relates to a method to promote a more uniform temperature across the engine which preferably leads to better or improved uniform combustion in the engine by using a coolant composition containing at least cesium formate in the radiator or cooling system.

It is to be understood that both the foregoing general description and the following detailed description are exemplary and explanatory only and are intended to provide a further explanation of the present invention, as claimed.

### BRIEF DESCRIPTION OF THE DRAWINGS

The present invention may be more fully understood with reference to the attached drawings, wherein:

FIG. 1 is a graph showing the effect of density and viscosity on crystallization melting temperature for a blended formulation; and

FIG. 2 is a graph showing the relationship between the molar percent of cesium fornate in a blended composition on both viscosity and density.

### DETAILED DESCRIPTION OF THE PRESENT INVENTION

The present invention relates to the use of cesium formate or coolant compositions containing at least cesium formate in a radiator or other cooling devices or cooling systems or other apparatuses for purposes of preferably promoting one or more benefits.

The concentration of the cesium formate in solution in the coolant composition can be any concentration that permits the ability of the coolant composition to act as a coolant composition in an engine, such as an internal combustion engine. For purposes of the present invention, the cesium formate solution can be used alone or in combination with water, or can be combined with other coolant compositions such as other alkali metal salts or other ingredients such as glycol containing ingredients. Conventional additives typically used in conventional coolant compositions can be used as well in the coolant compositions of the present invention.

The cesium formate can be obtained from Cabot Corporation. The cesium formate can be made, for instance, by following the description as set forth in International Published Patent Application No. WO 96/31435, incorporated in its entirety by reference herein. The cesium formate that is present in the coolant composition, preferably as a soluble salt, as stated above, can be present in any concentration and the cesium formate solution is a liquid at room temperature. Therefore, the concentration of the cesium formate in the coolant composition can be from about 1% by weight to the saturation point of the cesium formate in the solution, and more preferably is present in an amount of from about 40% to about 95% by weight and even more preferably is present in the coolant composition at a range of from about 75% to about 85% by weight or is present in the coolant composition at a range of from about 80% to about 85% by weight. The remainder of the coolant composition can be water or other aqueous solutions. Other conventional ingredients used in cooling compositions can be used with the coolant composition of the present invention.

The pH of the cesium formate that is present in the coolant composition can be any pH. Preferably, the pH of the cesium formate is from about 5 to about 12, more preferably from about 7 to about 11, and most preferably from about 8 to about 10. The cesium formate can have its pH adjusted by standard buffering techniques such as with the use of KOH and/or potassium carbonate and potassium bicarbonate or other buffering agents which are compatible with the cesium formate.

The cesium formate that is present is preferably a fully saturated or nearly fully saturated solution containing cesium formate. Preferably, the specific gravity of the cesium formate solution is 2.04 sg or higher. When the coolant composition further contains other formates such as potassium formate, the potassium formate that is used preferably has a specific gravity of about 1.54. As shown below, combinations of the cesium formate with potassium formate provide beneficial properties and provide a means to adjust the overall specific gravity of the coolant composition which can be used to tailor the properties of the composition based on the various uses.

The coolant compositions of the present invention preferably have a significantly higher heat transfer coefficient compared to 50/50 ethylene glycol or propylene glycol and without any sacrifice in the boiling protection. For example, with the fluid velocity held constant at 2.2 m/s, the cesium formate, preferably 2.04 sg, had a 56% higher heat transfer coefficient than 50/50 ethylene glycol. Furthermore, in view of the high boiling temperatures achieved with the cooling compositions of the present invention such as high temperatures on the order of about 157° C. or higher, engines can be run at higher temperatures and other benefits related to this advantage are possible.

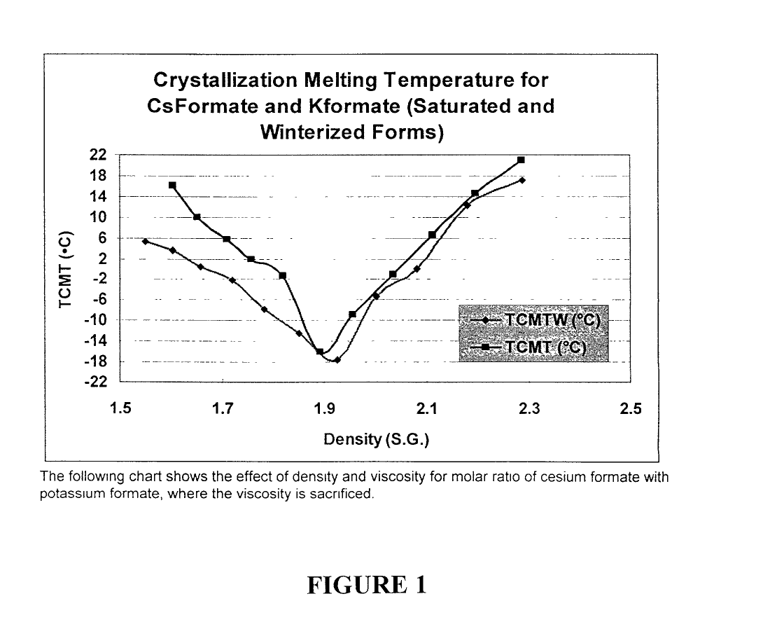

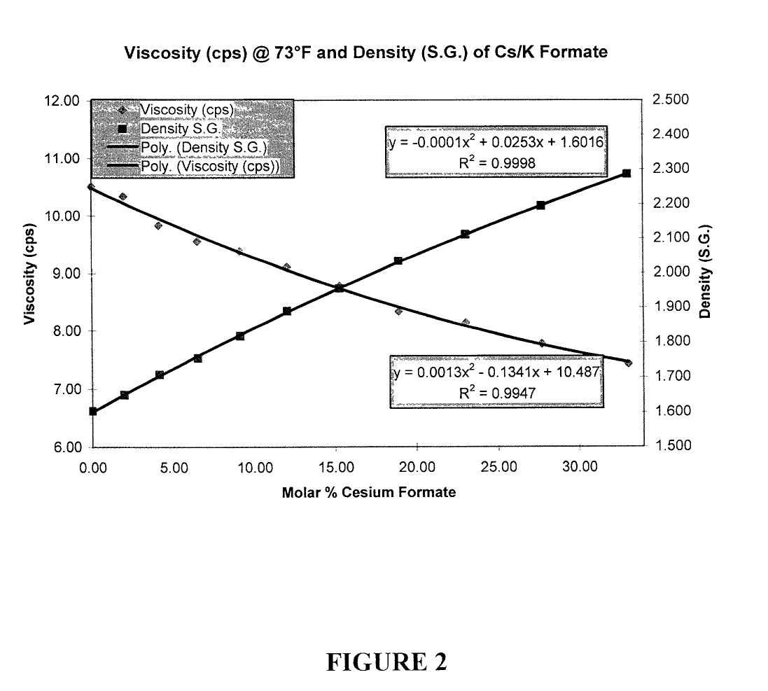

In another embodiment of the present invention, the coolant containing the cesium formate can also contain other alkali earth metal formates such as potassium formate. A mixture of cesium formate with potassium formate can produce excellent suppressed crystallization temperatures compared to cesium formate alone. For instance, when the mixture of potassium formate with cesium formate is formed having a specific gravity of about 1.9, the crystallization temperature can be suppressed to about −18° C. Thus, the eutectic behavior of the blended cesium formate and potassium formate with a density of about 1.92 sg provides crystallization temperatures of about −18° C. FIGS. 1 and 2 provide a showing of the crystallization melting temperatures for such a blended formulation as well as a density and viscosity comparison.

The coolant composition containing at least the cesium formate can be used in any application where other coolant compositions are used. These various uses of coolant compositions which can be replaced with the coolant compositions of the present invention are considered embodiments of the present invention.

For instance, the coolant compositions of the present invention can be used in radiators or other cooling devices or systems using conventional amounts or other amounts of the coolant compositions of the present invention. Preferably, the amount of coolant composition is significantly less than conventional amounts. The coolant compositions of the present invention have or provide many advantages which conventional coolant compositions do not provide.

In more detail, the coolant compositions when used in a radiator or other cooling device or system are more effective at removing heat from the engine, and thus the engine can run at higher outputs without overheating. For instance, the standard coolant composition can typically reach a maximum temperature of from about 200° F. to about 225° F. which thereby limits the engine's capabilities. However, with the use of the coolant compositions of the present invention, the coolant temperature can reach temperatures above 225° F. and exceed 300° F. such as 325° F. without any negative effects on the coolant composition. This ability for the coolant to be effective at these high temperatures directly leads to the ability for better engine performance which can lead to higher horsepower and/or speeds and other advantages.

Furthermore, with the coolant compositions of the present invention, the grill surface area or heat exchange surface area of a radiator or cooling device can be significantly less, such as 10% smaller, 20% smaller, or more since the coolant compositions of the present invention are better heat transfer agents for purposes of moving heat from one location to another. Therefore, with a grill surface area or heat exchange surface area that is smaller than conventional grill surface areas or conventional heat exchange surface areas, the radiator can be smaller. Furthermore, a vehicle, such as a race car, can go faster because if the grill surface area or heat exchange surface area can be smaller, less drag results on the vehicle which then permits the vehicle to have better aerodynamics which leads to the ability of the vehicle to move faster. In other words, the down force gained on the front of the vehicle and the reduced drag force permits the vehicle to then move faster. Further, with this improved front-end down force, the balance of the car is significantly improved especially, in, through, and out of turns. Also, with less air drag, the fuel efficiency of the vehicle is improved. The use of the coolant composition of the present invention in radiators and other cooling devices requires less air flow through the radiator or cooling device to cool the coolant composition since the coolant composition of the present invention is an excellent heat transfer agent which thereby requires less surface area to transfer the heat in the coolant composition to the atmosphere through the grill or heat exchange surface. Operating at higher coolant temperatures improves the efficiency of the radiator or cooling device. As stated, the coolant composition containing at least cesium formate is a significantly better heat transfer agent which thereby more efficiently removes heat from the engine which improves the ability of the engine to maintain higher operating output which can improve fuel efficiency and other operating improvements. For instance, using the coolant composition of the present invention, a 10% horsepower or more improvement can be achieved. This is a significant improvement for vehicles, which is achieved by using the coolant compositions of the present invention.

In one embodiment of the present invention, the present invention relates to a process for cooling an apparatus using the coolant composition of the present invention. For instance, an internal combustion engine with a cooling system cooled by coolant compositions can benefit from the coolant compositions of the present invention.

With the coolant composition of the present invention, the engine can operate at more uniform temperatures across the engine and the engine block and thereby promote a better and/or more uniform combustion occurring in the engine. This leads to greater fuel efficiency and/or other operating benefits.

As indicated above, the coolant composition of the present invention or cesium formate alone has the ability to promote corrosion resistance in radiators and other cooling surfaces as well as on other surfaces of apparatuses.

In addition, the coolant compositions of the present invention or cesium formate alone has the ability to be a cleaning agent (e.g., such as corrosion cleaner) which cleans the internal surfaces of radiators and other cooling devices as well as other apparatuses merely by incorporating the cesium formate or coolant composition of the present invention in the radiator or cooling device or other apparatus.

As indicated above, the coolant compositions of the present invention also permit reduction in the amount of coolant composition needed to effectively act as a coolant for engines and other operating apparatuses. The amount of coolant reduction can be 10%, 20%, or 30% by volume or more.

The coolant compositions of the present invention can be beneficial when used in automobiles, heavy equipment, aircraft, boats, ships, lawn mowers, tractors, motorcycles, and other moving vehicles, refrigerators and air conditioners, and the like, or apparatus having an engine or motor (gas, electric, etc.) with a cooling system.

Heat Transfer Coefficients were calculated for cesium formate fluids at their baseline fluid property values and for each fluid property varied independently over the given percentage range. This data was generated at both 93° C. (200° F.) and 138° C. (280° F.).

The effect of independently varying each fluid property on calculated HTC is well demonstrated. Increasing bulk coolant temperature appears to have little effect on the system except for the expected change in overall HTC value—changing individual coolant properties shows similar trends regardless of temperature. Accordingly, the coolants of the present invention are extremely efficient in transferring heat at elevated temperatures which is quite impressive and unexpected.

Other embodiments of the present invention will be apparent to those skilled in the art from consideration of the specification and practice of the invention disclosed herein. It is intended that the specification be considered as exemplary only, with a true scope and spirit of the invention being indicated by the following claims and equivalents thereof.

What is claimed is:

1. A coolant composition comprising at least cesium formate.

2. A cleaning composition comprising at least cesium formate.

3. A corrosion inhibitor comprising at least cesium formate.

4. The coolant composition of claim 1, wherein said cesium formate has a specific gravity of about 2.04 or higher.

5. The coolant composition of claim 1, further comprising potassium formate.

6. The coolant composition of claim 1, wherein said cesium formate is fully saturated in said coolant composition.

7. A method to reduce the size of a radiator or other cooling device comprising the use of the coolant composition of claim 1.

8. A radiator or other cooling device comprising a radiator or other cooling device and the coolant composition of claim 1.

9. A method to reduce the surface area of a grill or heat exchange surface area on a radiator or cooling device comprising introducing the coolant composition of claim 1 in said radiator or cooling device.

10. A method to increase the speed of a vehicle comprising the incorporation of the coolant composition of claim 1 into the cooling system of the vehicle.

11. A method to reduce the amount of coolant composition in a radiator or cooling device comprising the use of the coolant composition of claim 1.

12. A method to obtain an improved uniform engine operating temperature across the entire surface area of the engine comprising the use of the coolant composition of claim 1 in the engine cooling system.

13. A process for cooling an apparatus having a cooling system comprising the use of the coolant composition of claim 1.

14. A method to improve the aerodynamic performance of a vehicle comprising the use of a cooling system which contains the coolant composition of claim 1 and reducing the air flow necessary to maintain engine operating temperatures.

15. A method to increase the fuel efficiency of a vehicle having a cooling system comprising the use of the coolant composition of claim 1.

16. A vehicle comprising a cooling system, wherein said cooling system contains the coolant composition of claim 1.

17. A coolant composition comprising an additive capable of operating at temperatures of from above 230° F. to about 325° F., or higher.

18. An engine comprising the coolant composition of claim 1 in the cooling cavities of the engine.

19. A cooling system comprising an apparatus for containment of a coolant and the coolant composition of claim 1 contained therein.

20. The coolant composition of claim 1, further comprising water.

21. An engine cooling system comprising a means for circulation of a coolant solution through an engine, wherein said coolant solution comprises the coolant composition of claim 1.

22. A system having a motor and a means for cooling the system using a coolant solution wherein said solution comprises the coolant composition of claim 1.

23. The system of claim 19, wherein said motor is an electric motor.
